(19) United States
(12) Patent Application Publication
(10) Pub. No.: US 2001/0011279 A1
(43) Pub. Date: Aug. 2, 2001

(54) INTERACTIVE LABEL SELECTION SYSTEM

(76) Inventor: ELIAS HAJJAR, ANAHEIM, CA (US)

Correspondence Address: OPPENHEIMER WOLFF & DONNELLY, 2029 CENTURY PARK EAST 38TH FLOOR, LOS ANGELES, CA, 900673024

(21) Appl. No.: 09/189,565

(22) Filed: Nov. 11, 1998

(51) Int. Cl. G06F 17/30

(52) U.S. Cl. 707/206

(57) ABSTRACT

The present invention relates to an interactive label selection system that permits the user to quickly and conveniently locate label products having characteristics that meet the users needs. The user inputs desired label characteristics, and the system searches a database for label products that have or that approximate those characteristics. The search results are then output by the system for the user's review or for further processing. One embodiment of the invention relates to an interactive, electronic method for finding label products that are suitable to meet a user's label needs based on minimum and maximum label width and height dimensions that the user inputs into an input device. Minimum and maximum label dimensions are input into an input device at a remote location. The minimum and maximum label dimensions are then transmitted across a computer network to a server. Information including label dimensions and corresponding product numbers for a plurality of different label products are stored in a database. The database is searched to find information about each label product having label dimensions that fall within the minimum and maximum dimensions. The search results are then transmitted from the server to an output device at the remote location, and displayed on the output device at the remote location.

### BACKGROUND OF THE INVENTION

Blank pressure sensitive adhesive labels are used in homes and offices to custom print a wide variety of labels, such as address labels, compact disc labels, product labels, and numerous other types of labels. Manufacturers of blank labels include the Avery Dennison Corporation, which makes and sells an extensive line of labels that vary in label size, shape, material, color, and the size of the sheet on which the labels are provided. Each individual label product is assigned a product number, also known as an SKU number, to identify that particular product.

For the consumer, finding the appropriate label for a particular application can be time consuming. Label manufacturers typically provide large tables of information that list the SKU number of each product along with various other information about the product. FIG. 1 illustrates a prior art product information table 10 having various columns 12-18. Column 12 lists SKU numbers for a variety of products. Column 14 lists label width and height, column 16 lists number of labels per sheet, and column 18 lists the number of sheets per package. Other columns may also be provided to indicate the color of the labels, the size of the sheet on which the labels are provided, and other information such as the type of adhesive that backs the labels.

To find a suitable label product for a particular application, a user in the past has typically had to search through a table such as that illustrated in FIG. 1 in order to find a label product having the height and/or width and/or sheet size and/or number of labels per sheet and/or other criteria that the user requires. This process has often been slow and cumbersome, particularly when the table that is provided for the user is necessarily large because of the large number of different available label products.

One example of an attempt to simplify this process permits the user to enter an SKU number into an input screen. The system returns information about that particular label product. This system is of very limited utility, however, because the user must know the SKU number of the product that he or she desires—in advance—in order to find information about that product.

The usual situation is one in which the user knows something about the specifications of the label products that he or she desires, but does not know the product number or SKU number of the label product or products that will satisfy those needs. For example, a user may know that he or she needs a label that is between 1 and 2 inches wide by between ⅜″ to ½″ high. The user may also know that he or she desires only a relatively small number of labels per sheet because the size of the printing job for which she will use the sheet is small. However, the prior art does not permit the user to efficiently and electronically match her requirements with particular label products that satisfy those requirements.

### SUMMARY OF THE INVENTION

Broadly defined, the present invention relates to an interactive label selection system that permits the user to quickly and conveniently locate label products having characteristics that meet the users needs. The user inputs desired label characteristics, and the system searches a database for label products that have, or that approximate, those characteristics. The search results are then output by the system for the user's review or for further processing.

One embodiment of the invention relates to an interactive, electronic method for finding label products that are suitable to meet a user's label needs based on minimum and maximum label width and height dimensions that the user inputs into an input device. Minimum and maximum label dimensions are input into an input device at a remote location. The minimum and maximum label dimensions are then transmitted across a computer network to a server. Information including label dimensions and corresponding product numbers for a plurality of different label products are stored in a database. The database is searched to find information about each label product having label dimensions that fall within the minimum and maximum dimensions. The search results are then transmitted from the server to an output device at the remote location, and displayed on the output device at the remote location.

Another embodiment of the invention relates to an interactive label product selection system that has a data input device. The input device includes a data input screen displaying a plurality of label search modes. One of the modes involves definition of desired labels by dimensions, and another mode involves visual review of groups of available label sheets. The system includes an electronic database in which is stored product identification and description data for a plurality of different label products. A computer is interconnected with the input device and the database and is programmed with a searching routine adapted to search the database for product identification and description data according to each of the label search modes. A data output device is interconnected with the computer for displaying product identification and description data transmitted from the computer.

In accordance with another aspect of the present invention, an interactive label product selection system includes data input means for receiving user-defined label criteria selected from among such variables as label width, label height, label sheet size, label shape, and number of labels per sheet. The system also includes database means for storing product identification and description data for a plurality of different label products. Means are provided for searching the database means in response to the user-defined label criteria to locate label products that meet the user-defined label dimension criteria. The system also has data output means for displaying the product identification data that meets the user-defined label criteria.

In accordance with another aspect of the present invention, an interactive label product selection system has a data input device for receiving user-defined label criteria selected from a group comprising label width, label height, label sheet size, label shape, and number of labels per sheet. An electronic database in which is stored product identification and description data for a plurality of different label products is provided. A computer is interconnected with the input device and the database and is programmed with a searching routine adapted to search the database for product identification and description data corresponding to any of the plurality of label products that satisfy the user-defined label criteria. A data output device that is interconnected with the computer is provided for displaying the product identification and description data that meets the user-defined label criteria.

In accordance with another aspect of the invention, one interactive label selection method has several steps. The steps include inputting user-defined label dimension criteria into an input device; storing label dimension and label product identification information in an electronic database; searching the electronic database to identify label products meeting the user-defined label dimension criteria; and outputting label product identification information corresponding to label products satisfying the user-defined label dimension criteria to an output device.

In accordance with yet another aspect of the invention, another interactive label selection method has several steps. Those steps include receiving user-input user-defined label criteria selected from a group comprising label width, label height, label sheet size, label shape, and number of labels per sheet from an input device; storing label product specifications and label product identification information in an electronic database; searching the electronic database to identify label products meeting the user-defined label criteria; transmitting label product identification information corresponding to label products satisfying said user-defined label criteria to an output device.

This has been a brief summary of key points about the invention. However, there are various other aspects of the invention, as will become apparent from studying the drawings, the Detailed Description that follows, and the claims.

### BRIEF DESCRIPTION OF THE DRAWINGS

FIG. 1 is a prior art printed comparison chart listing data about several different label products;

FIG. 2 illustrates a common input/output device connected to a server via a network such as the Internet;

FIG. 3 is a flow diagram illustrating the logic behind an interactive label selection system according to the present invention;

FIG. 4 illustrates one embodiment of an input screen onto which the user enters physical information regarding the labels he or she requires;

FIG. 5 illustrates one embodiment of an output screen onto which the system outputs descriptions of label products that meet the user's requirements; and

FIG. 6 illustrates an alternative embodiment of an input screen for the present invention.

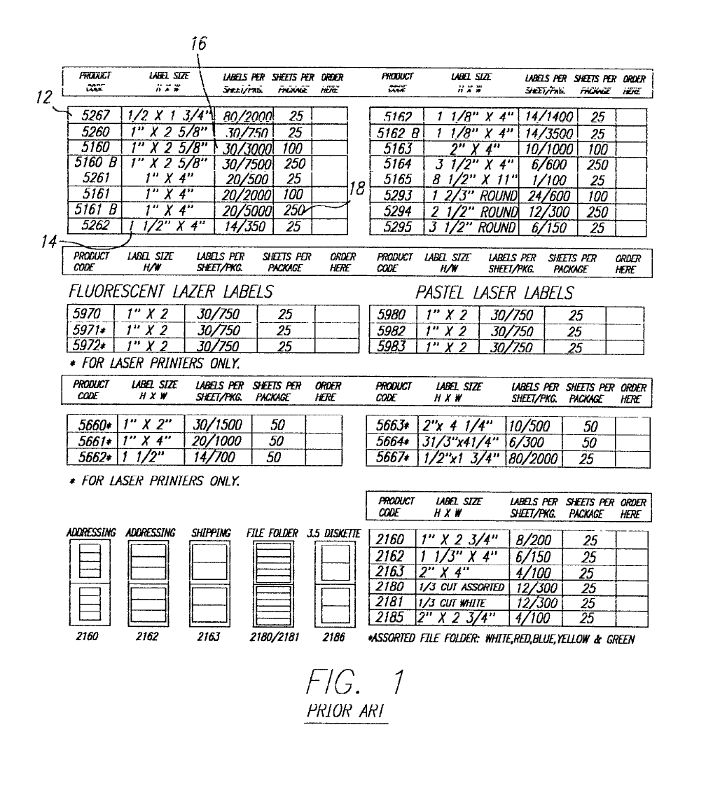

### DETAILED DESCRIPTION OF THE PREFERRED EMBODIMENT

Referring to FIG. 2, a personal computer 20 is shown interconnected with a network 22 to which a server 24 is connected. The personal computer 20 has an input device 26, which is a keyboard, and an output device 28, which is a computer monitor. The personal computer 20 may have other types of input and output devices, such as for example, a microphone for input of voice data and a speaker for output of audio data. Other types of suitable output devices include printers of hard drives, floppy disc drives, zip drives, and other output devices known in the art. Suitable input devices include hard drives, floppy drives, zip drives, computer mice, touch-sensitive computer monitors, and other sorts of input devices known in the art.

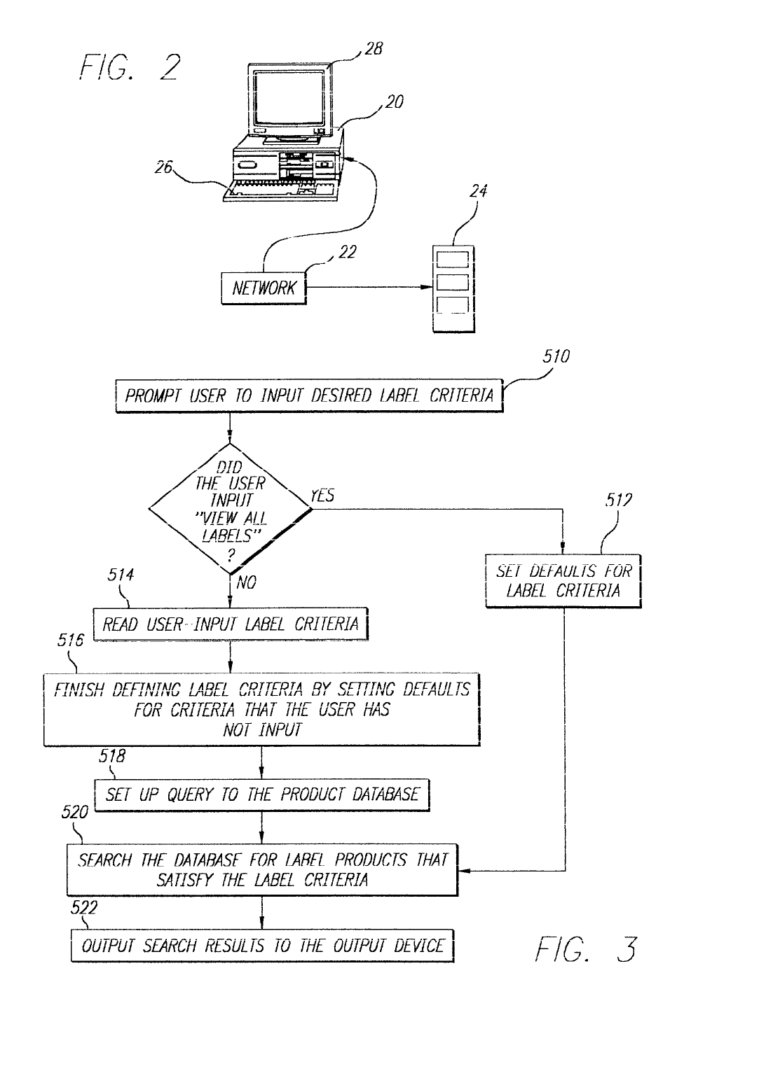

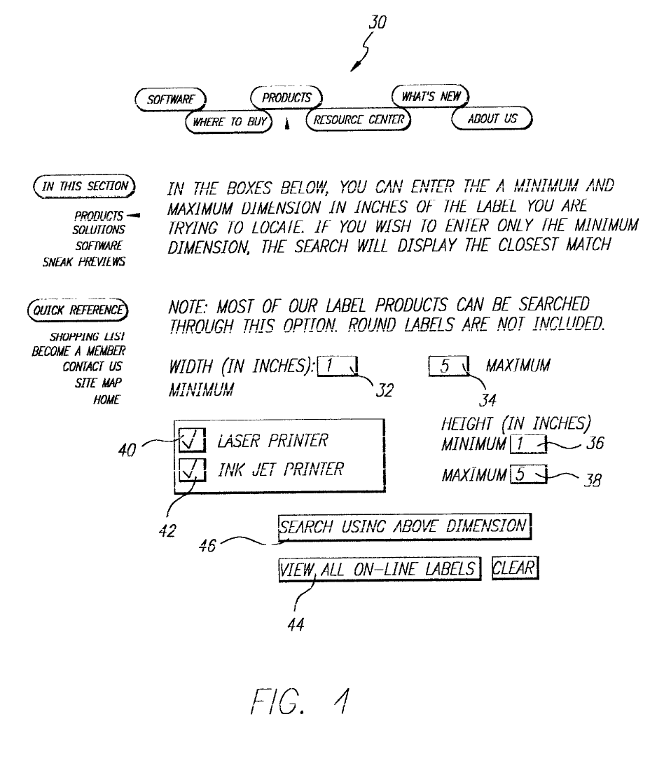

In the preferred embodiment of the present invention, the personal computer 20 functions primarily to transmit user-input data through a network 22 to a server 24, and then receives search results back from service 24 through the network 22 for display on the monitor 28. When the personal computer 20 initially interconnects with server 24 through network 22, the server 24 transmits instructions and information to personal computer 20 to display an input screen on monitor 28. Referring to the flow diagram of FIG. 3, step S10 relates to prompting the user to input desired minimum and maximum label width and height information into the personal computer 20. In some embodiments of the present invention, the input screen may also prompt the user to select the type of printer that the user intends to use to print the labels, such as a laser jet or ink jet printer.

FIG. 4 illustrates one embodiment of an input screen that prompts the user to input label criteria. The screen 30 includes a space 32 to define a minimum acceptable label width, a space 34 for the user to define the maximum desired label width, and spaces 36 and 38 in which the user may define minimum and maximum acceptable label heights, respectively. The input screen 30 may also include prompts 40 and 42 with which the user may define the type of printer he or she intends to use with the labels. The screen 30 may also offer an option 44 for the user to simply request that all label products stored in a data base be displayed on the screen and a bar 46 that the user may click in order to search the database using the data that the user has input into boxes 32 through 42.

Once the user has input information into input boxes 32-42, the user will typically click on bar 46 by means of a computer mouse in order to search a data base accessible by the server 24 of various label products that satisfy the user-input label product criteria. Once the user has clicked on bar 46, the various data that the user has input into areas 32-34 is transmitted from the personal computer 20 through the network 22 and to the server 24, which runs a label search control program. This step is generally illustrated in FIG. 3 as step S14.

The label search control program reviews the data that the user has input into the input screen 30 and, for any of the input areas 32-42 that the user has left blank, assigns default values. FIG. 3 illustrates this step at reference numeral S16. In the presently preferred embodiment of the invention, the default values for an 8½″ by 11″ sheet of labels are as follows: 0″ for minimum label width and height; 8½″ for maximum width; 11″ for maximum height; and both laser and ink jet printer for type of printer.

On the other hand, if the user clicks on bar 44 to view information on all of the label products in the data base, the label search control program simply sets defaults for all of the variables normally input in input boxes 32-42, as indicated at step S12 in FIG. 3.

Once the search control variables have either been defined by the user or have been assigned default values by the search control program, the parameters are sent to the database in order to initiate a search of the database for label products that meet the criteria that the user has input or that have been assigned by default. The database typically holds information pertaining to various label products for each label product. The database includes entrees for the product number, or SKU number, the name of the product, and the height of the labels that are provided with the product, the size of the sheets on which the labels are provided, the type of printer with which the labels are intended to be used, and a photograph, line drawing, or other graphical representation of the labels as provided on the sheet and/or as used on products. The illustrations are typically provided in JPG format, although any of a variety of other graphical formats may be used. The database may be any of a number of commercially available databases, although the presently preferred commercial database is the ORACLE database, which is available from the ORACLE Company of Redwood City, Calif. Other suitable databases include Sybase, which is available from Sybase, Inc. of Emeryville, Calif., Informix, which is available from Informix Software, Inc. of Menlo Park, Calif., Microsoft SQL Server and MS ACCESS, both of which are available from Microsoft of Redmond, Wash., among others. The search control program typically sends queries to the database by means of a database query language such as Structured Querly Language (SQL). SQL is a language known in the art that allows the user to define, access and manipulate data in relational database management system.

Using SQL commands or commands from another database query language, the server can initiate any of a number of different types of searches of the database. In one embodiment of the present invention, the search control program initiates a search of the database to find all label products that have labels with a width and a height that falls within the range defined by the minimum and maximum label width and height respectively. So, if the user were to define a minimum label width of 1 inch, a maximum label width of 2 inches, a minimum label height of ½ inch, and a maximum label height of 1 inch, the database search control program would initiate a search of the database for all label products having label widths and height that fall within the range defined by the user. If the user specifies that the labels are to be used in laser printers only, the database search control program then initiates a search of the database for all label products having labels within the height and width range that the user has defined, and that are intended for use in laser printers. FIG. 3 illustrates the step of setting up the database query as step S18.

In other embodiments of present invention, the user can be prompted to input various other information that can be used to search the database. For example, the user can be prompted to input a minimum and maximum number of labels per page. The user may also be prompted to input data about the size of sheet on which the user wishes the labels to be provided. The user may also input the shape of the label that the user desires the type of adhesive that is applied to the labels, and so on. Consequently, the present invention is not limited merely to systems in which the user inputs minimum and maximum height width values, but can be extended to various other characteristics of the labels themselves and/or the manner in which the labels are provided.

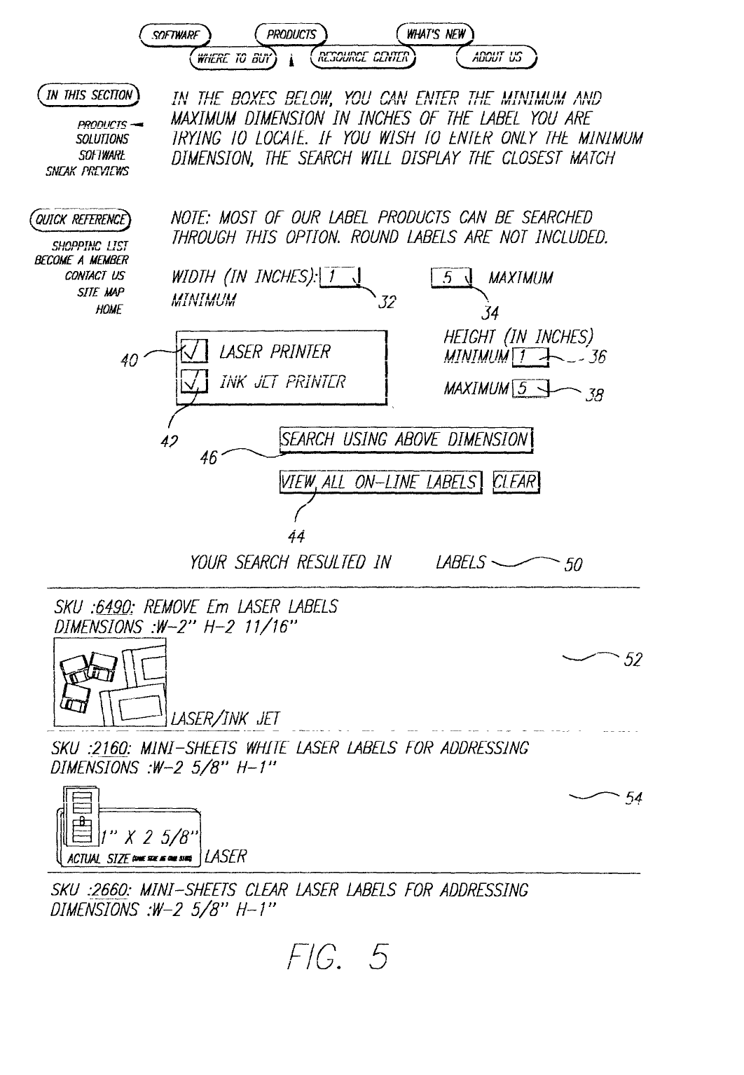

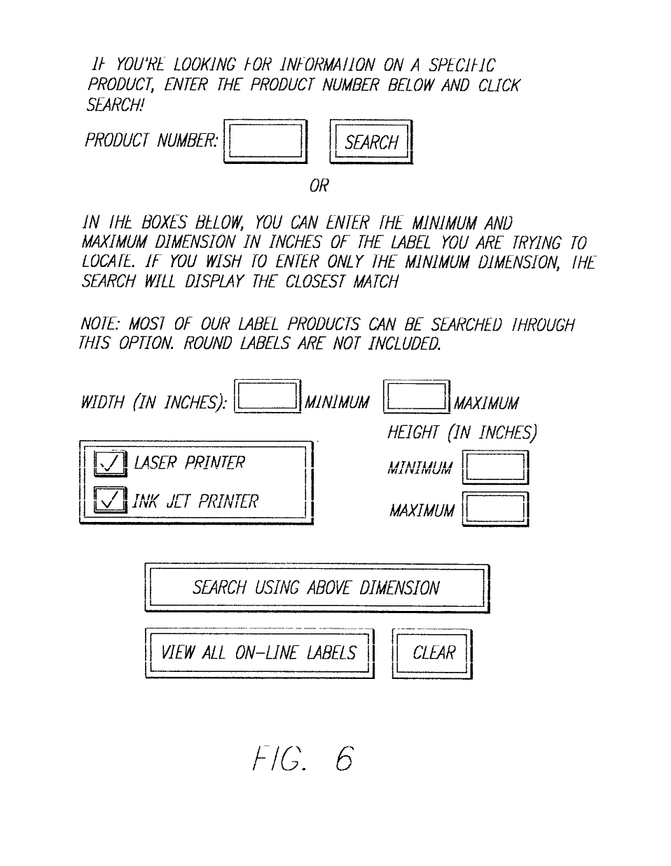

Referring to step S20 in FIG. 3, the database management system conducts the search that the search control program has initiated and returns to the search control program various information about each label product that needs the search criteria. Typically, the information includes the products or SKU number, the title of the product, the dimensions of the label, whether the product is for laser or ink jet printers. Depending on what information is in the database, the database management system may return additional information, such as the size of the sheet on which the labels are provided, the type of material from which the labels are made, various other physical characteristics of the product, such as whether the product is dye cut or perforated in some manner, the color of the labels, and other information. Typically, the database also return a graphic file of either a photograph of the labels as they are intended to be used or a line art drawing of the label sheets themselves with various information about the sheet incorporated into the line art. The server then transmits the data back through the network 22 to the personal computer 20 and displays the information on the output device 28 in a form such as that illustrated in FIG. 5. The output on output device 28 typically includes a replica of the input data screen 30 followed by information relating to the number of label of products found 50 and individual entries 52, 54, etc. as appropriate for the various products found during the search. Once the output is displayed on output device 28, the user may scroll through the results in order to review the various label products that meet the users specified criteria. FIG. 3 illustrates the step of outputting search results on an output device as step S22.

Attached hereto as Appendix A is a flow diagram illustrating the manner in which one embodiment of the interactive label selection system operates. It should be understood that the flow diagram of Appendix A relates to only a presently preferred embodiment of the present invention and that various other embodiments may be included within the scope of the invention.

While a presently preferred embodiment of the present invention has been defined, it should be understood that various changes may be made to the system within the scope of the invention. For example, the input/output device is not limited to being the personal computer 20, but may be various other types of devices. For example, an appliance or other device that is interconnected with a network may initiate queries entirely on its own to the server in order to gather information about label products for a particular purpose. Thus, a printer having a microprocessor system may keep track over time of the types of labels that the user typically prints. If the printer itself is interconnected through a network to a server, such as server 24 and FIG. 2, the printer on its own initiative may send on inquiry to the server for information about various label products that are compatible with the type of labels that the user typically prints. The printer may then print out information for the user about label products that the user might consider using instead of whatever label products the user typically uses.

In other embodiments of the present invention, the user does not necessarily need to input minimum and maximum label dimensions. Instead, the user may input a single desired width and a single desired label height, and then the search control program may be adapted to calculate minimum and maximum values for both the label width and height. The search control program might calculate an acceptable minimum and maximum for each of the width and height by simply adding and/or subtracting a particular constant dimension from each of the user input dimensions to generate a minimum and maximum. For example, the program can generate minimum and maximum widths using the formulas Wₘₐₓ=W+K_{w} and Wₘᵢₙ=W−K_{w}, where Wₘₐₓ is the maximum acceptable width, W is the user-input desired width and K_{w} is a constant such as ½″, ⅜″, ¼″ or other suitable dimension. Similarly, minimum and maximum height values Hₘᵢₙ and Hₘₐₓ can be calculated. A query is then sent to the database to locate all label products having a width Wₚ and a height Hₚ such that Wₘₐₓ≧Wₚ≧Wₘᵢₙ and Hₘₐₓ≧Hₚ≧Hₘᵢₙ.

Alternatively, the search control program may simply ask the data management program to search for products that have label characteristics that are the closest to those which the user has input. Various other types of searches may be performed.

In one alternative embodiment, the user may choose between searching by SKU number, by label shape, by label dimension (height and width for rectangular labels; diameter for round labels); and/or by type of printer (laser, inkjet and the like). The user may also choose to view all of the label products in the database. An example input screen for this embodiment is illustrated in FIG. 6.

Consequently, the present invention is not limited to the detailed description of a preferred embodiment presented above.

What is claimed is:

1. An interactive, electronic method for finding label products that are suitable to meet a user's label needs, based on minimum and maximum label width and height dimensions that a user inputs into an input device, the method comprising the steps of:
inputting minimum and maximum label dimensions into an input device at a remote location;
transmitting the minimum and maximum label dimensions across a computer network to a server;
storing information including label dimensions and corresponding product numbers for a plurality of different label products in a database;
searching the database to find information about each label product having label dimensions that fall within the range defined by the minimum and maximum dimensions transmitted from the remote input device to the server;
transmitting search results from the step of searching the database from the server to an output device at the remote location; and
displaying the search results on the output device at the remote location.

2. An interactive, electronic method for finding label products as defined in claim 1, wherein the step of inputting minimum and maximum label dimensions comprises inputting a minimum label width, a maximum label width, a minimum label height and a maximum label height.

3. An interactive, electronic method for finding label products as defined in claim 1, further comprising the steps of inputting a desired number of labels per sheet of labels and searching the database to find information about each label product having the number of labels per sheet that was input.

4. An interactive, electronic method for finding label products as defined in claim 1 further comprising the step of assigning default values to label dimensions not defined in the inputting step.

5. An interactive, electronic method for finding label products as defined in claim 1, wherein a client computer comprises the input and output devices.

6. An interactive label product selection system comprising:
data input means for receiving user-defined label criteria selected from a group comprising label width, label height, label sheet size, label shape, and number of labels per sheet;
database means for storing product identification and description data for a plurality of different label products;
means for searching said database means in response to said user-defined label criteria to locate label products that meet said user-defined label dimension criteria;
data output means for displaying said product identification data that meets said user-defined label criteria.

7. An interactive label product selection system as defined in claim 6, wherein the label width and height comprise respective minimum and maximum values of width and height.

8. An interactive label product selection system as defined in claim 6, wherein the description data includes graphics illustrating the respective products.

9. An interactive label product selection system as defined in claim 6, wherein the data input and output means are a computer.

10. An interactive label product selection system comprising:
a data input device for receiving user-defined label criteria selected from a group comprising label width, label height, label sheet size, label shape, and number of labels per sheet;
an electronic database in which is stored product identification and description data for a plurality of different label products;
a computer that is interconnected with said input device and said database and that is programmed with a searching routine adapted to search the database for product identification and description data corresponding to any of said plurality of label products that satisfy said user-defined label criteria; and
a data output device that is interconnected with said computer for displaying said product identification and description data that meets said user-defined label criteria.

11. An interactive label product selection system as defined in claim 10, wherein the label width and height comprise a maximum width, a minimum width, a maximum height and a minimum height.

12. An interactive label product selection system as defined in claim 11, wherein the user-defined label dimension criteria are the label width and length.

13. An interactive label product selection system as defined in claim 11, wherein the user-defined label dimension criteria are number of labels per sheet of labels.

14. A interactive label selection method comprising the steps of:
inputting user-defined label dimension criteria into an input device;
storing label dimension and label product identification information in an electronic database;
searching the electronic database to identify label products meeting the user-defined label dimension criteria;
outputting label product identification information corresponding to label products satisfying said user-defined label dimension criteria to an output device.

15. An interactive label selection method as defined in claim 14 wherein the step of inputting user-defined label dimension criteria comprises inputting a width and a height and calculating a range of acceptable minimum and maximum widths and heights based on the user-defined width and height.

16. An interactive label selection method as defined in claim 14 wherein the step of inputting user-defined label dimension criteria comprises inputting a desired label height and width, and wherein the step of searching the electronic database to identify label products comprises searching for label products most nearly having the user-defined label height and width.

17. An interactive label selection method as defined in claim 14 wherein the method further comprises the step of inputting a user-defined number of labels per sheet and searching the database for label product information corresponding to label products with substantially the same number of labels per sheet as the user-defined number of labels per sheet.

18. An interactive label selection method as defined in claim 14 wherein the database is stored on a network server and the method further comprises the steps of transmitting the user-defined data across the network to the server and the outputting step comprises transmitting information from the server across the network to a remote location.

19. An interactive label selection method as defined in claim 14 wherein the input and output devices are attached to a personal computer and said database is stored on the personal computer.

20. An interactive label selection method as defined in claim 14 wherein the input and output devices are attached to a client computer that is interconnected to a computer network, and said database is stored a server on the network.

21. An interactive label selection method comprising the steps of:
receiving user-input user-defined label criteria selected from a group comprising label width, label height, label sheet size, label shape, and number of labels per sheet from an input device;
storing label product specifications and label product identification information in an electronic database;
searching the electronic database to identify label products meeting the user-defined label criteria;
transmitting label product identification information corresponding to label products satisfying said user-defined label criteria to an output device.

22. A network-based interactive label selection system comprising:
a computer network comprising at least one server supporting at least one client computer;
at least one client computer interconnected with said network;
said server including a control program for receiving desired label dimensions input at the client computer and for outputting search results to said client computer;
label product data including label product identifiers and corresponding label dimensions for a plurality of label products, said label product data being stored in an electronic storage media accessible by said server;
said server including a program for searching said label product data to find label product data corresponding to label products satisfying said desired label dimensions.

23. An interactive label product selection system comprising:
a data input device including a data input screen displaying a plurality of label search modes, wherein one of said modes involves definition of desired labels by dimensions, and another of said modes involves visual review of groups of available label sheets;
an electronic database in which is stored product identification and description data for a plurality of different label products;
a computer that is interconnected with said input device and said database and that is programmed with a searching routine adapted to search the database for product identification and description data according to each of said label search modes; and
a data output device that is interconnected with said computer for displaying product identification and description data transmitted from said computer.
